(19) United States
(12) Patent Application Publication
(10) Pub. No.: US 2007/0028088 A1
(43) Pub. Date: Feb. 1, 2007

(54) Polymorphic encryption method and system

(76) Inventors: Coskun Bayrak, Maumelle, AR (US); Umit M. Topaloglu, Little Rock, AR (US)

Correspondence Address: J. CHARLES DOUGHERTY, 200 WEST CAPITOL AVE, SUITE 2300, LITTLE ROCK, AR, 72201, US

(21) Appl. No.: 11/194,169

(22) Filed: Aug. 1, 2005

(51) Int. Cl. H04L 9/00

(52) U.S. Cl. 713/150

(57) ABSTRACT

The invention is directed to a symmetric encoding and decoding architecture for a communication system that may be implemented using multiple encoding levels. By changing the number of levels used, the system may be adapted to the user's speed and security requirements. Cryptoanalysis techniques attacking the encoding process may yield multiple meaningful messages, without the ability of the attacker to determine which message is the correct one. The encrypted messages may also be compressed according to an algorithm that is effective even for small message sizes, and an exclusive-OR (XOR) function may be applied to the result to thwart an attack by a party that knows the compression algorithm.

### BACKGROUND

The present invention relates to encryption methods, and in particular to symmetric encryption methods utilizing symbolic substitution.

For millennia, cryptography techniques have been used to protect the privacy of messages sent between remote parties. Parallel to the developments in cryptography techniques, however, powerful cryptanalysis tools have also been unveiled, requiring the development of ever newer and more sophisticated cryptography methods.

Cryptography is in wide use today with respect to messages sent by digital communications networks. While many good cryptographic tools exist today, almost all have associated deficiencies; they are either vulnerable to some well-known attacks, or require an unreasonably large time for the completion of the encoding or decoding processes.

Shift and substation ciphers are among the most simple cryptographic tools in use today. Shift Cipher, which shifts letters using the function mod 26, is easy to encrypt and decrypt, but it is poor for long sequences of English words. It has only 26 encoding possibilities, and due to the regular pattern, the encoding function encrypt (key, x) is the same for all occurrences of any particular letter. Shift Cipher and its strengthened version, Affine Ciphers, are in the category of substitution ciphers, and thus the well-known frequency count cryptoanalysis attack may be used to solve these with great effectiveness. Playfair Cipher, ADFGX Cipher, Block Cipher, Vigenere, and Hill Cipher are other classical cryptosystems examples, all of which are subject to attack with well-known cryptoanalysis tools.

Other than the classical approaches, some recently invented cryptosystems have become available; the two basic types of modern cryptographic systems are secret key (symmetric cryptography) and public/private key cryptography. In the secret key approach, the same key is used for encryption and decryption of the message text, while public key systems uses two different keys. Transferring the key to the receiver in a secure medium, which often proves to be a difficult task, is the disadvantage of secret key algorithms, and the reason for the popularity of public/private key systems.

The most widely known secret key algorithm is the National Security Agency (NSA) sponsored Data Encryption Standard (DES), which divides message text into blocks of 64 bits and encrypts each block separately. Although DES is one of the most widely used secret key algorithms, and relies upon a 56-bit key yielding 2⁵⁶, that is, 7.2×10¹⁶ possible keys, recent investigations indicate that DES is no longer secure. The continuing increase in available computing power means that DES may be open to a brute force search type of attack, in which all possible keys are tried sequentially. In order to increase the security of DES, researchers have used two approaches: expanding the key size, and using variants of DES such as Triple DES. Both of these approaches, however, increase the computational burden of using DES for the encryption and decryption of messages.

In contrast to symmetric key methods, the public key method encrypts message text using an algorithm that only a private key can decrypt. In this approach, each user has an available public key and a related secret private key. Based on the difficulty of factoring large integers, Rivest, Shamir, and Adleman created the RSA algorithm, which is well known for public key encryption and digital signatures. The disadvantage of RSA compared to symmetric encryption is the greater amount of processing time required for the necessary calculations. Diffie-Hellman, Elliptic Curve Crypto System (ECC), ElGamal, and Digital Signature Algorithms (DSA) are some of the other public key methods in use today. The basic idea behind the DSA technique is to associate something unique with each person. Senders encrypt the “digital fingerprint” of their documents with their own private keys. Anyone with access to the public key of the signer may verify the signature. Despite usefulness, this method has the possibility of collision and of pretend senders. To overcome these drawbacks, certification may be incorporated, where a trusted third party issues a unique certificate for users. This requirement of a trusted third party limits the usefulness and increases the costs associated with using this encryption technique.

Although the public key method has increased security and convenience, it suffers from computational speed. To gain the best results, messages may be encrypted using a secret key, and then the secret key is transferred using a public key algorithm. Thus the computational speed advantages of a symmetric key approach may be utilized once the key is exchanged. Existing symmetric key techniques, however, suffer from the disadvantages already described. In particular, the computational burden of these techniques increases dramatically as key size increases in order to defeat brute force-type attacks. As the computational speed available to cryptoanalysis routines continues to increase, this computational burden becomes an ever more important factor in cryptography system design.

The inventors have recognized that another area of digital technology with potential applicability to encryption techniques is file compression. It is not uncommon now for computer systems to involve gigabytes or even terabytes of data. The ability to reduce the size of very large files makes computer systems more economical and improves their performance, particularly when such files are being sent over a network. Video, audio, photograph, and document files are those that are most commonly exchanged over networks, and compression gives the ability to transfer those files in significantly shorter times.

File compression without data loss is made possible where one data representation is more frequent than others in a file. This is generally the case with the most commonly transmitted file types. The three main classes of compression algorithms in use today are finite context modeling, finite state modeling, and dictionary modeling.

As an example of the dictionary modeling approach, Lemp and Ziv developed a system based on an adaptive dictionary scheme. With improvements added by Welch, this algorithm is now known as “LZW” compression. It is easily implemented with most desktop computer systems and uses a sliding-window approach. The key insight of the method is that it is possible to automatically build a dictionary of previously seen strings in the text being compressed. The dictionary does not have to be transmitted with the compressed text, since the decompressor can build it the same way the compressor does, and if coded correctly, will have exactly the same strings that the compressor dictionary had at the same point in the text. The dictionary starts off with 256 entries, one for each possible character in a single-byte string. Every time a string not already in the dictionary is seen, a longer string consisting of that string appended with the single character following it in the text is stored in the dictionary. The output consists of integer indices into the dictionary. The disadvantage of such adaptive models is that compression cannot be applied at the beginning, so it is not useful for small files. Another disadvantage of LZW is that a sophisticated data structure is needed to handle the dictionary.

Another well-known alternative for file compression is Huffman coding. Huffman coding uses a variable-length code table for encoding a source symbol (such as a character in a file) where the variable-length code table has been derived in a particular way based on the estimated probability of occurrence for each possible value of the source symbol. Huffman coding uses a specific method for choosing the representation for each symbol, resulting in a prefix-free code (that is, the bit string representing some particular symbol is never a prefix of the bit string representing any other symbol) that expresses the most common characters using shorter strings of bits than are used for less common source symbols. For a set of symbols with a uniform probability distribution and a number of members which is a power of two, Huffman coding is equivalent to simple binary block encoding. It may be seen then that Huffman coding is optimal only when symbol probabilities are in fact powers of two. Another disadvantage of Huffman coding is that the input file needs to be read twice: once for building the tree, and again for coding the file. Yet another disadvantage is the necessity for sending the header so that the decompressor knows what the codes are.

Another common compression algorithm is arithmetic coding, where one word, which has half-open subintervals, is assigned to each possible set. Shorter codes correspond to larger subintervals, so more probably input data sets are represented by less code. The main disadvantages of this approach are that arithmetic coding tends to be slow, and some operations like the model lookup and update are also deliberate. Another disadvantage is that arithmetic coding is unable to produce a prefix code.

Yet another common example of compression is run length encoding. This approach finds redundant samples and sends the lengths of the redundant runs that occur between non-redundant samples. The results are not satisfying on regular text files, since these files have relatively few repetitions. In addition, run length encoding cannot compress very large files efficiently.

Finally, another common compression approach is the dynamic Markov chain (DMC). DMC is essentially a method to predict the probability of a given character based on what has come before it. DMC's principal disadvantage is that in real-world problems it often results in the consumption of very large amounts of memory, making it impractical for many applications, particularly where simple desktop computers are used.

It may be seen then that what is desired is a cryptographic system with the advantages of symmetric key methods, yet one that maintains a sufficiently low computational burden that its complexity may be increased to foil any realistic brute force attack. The inventors have recognized that the addition of a compression algorithm to the system would increase its performance by reducing the size of encrypted files that must be sent over a network, and would also increase the difficulty of successfully employing certain types of cryptoanalysis attacks upon the system.

### SUMMARY

The present invention is a symmetric encoding and decoding method with a multilevel ability. In various embodiments, the invention may include three different steps in order to increase its strength. The first step is the substitution of input to employ a varying strength level. The second step is to compress the result to increase the entropy associated with the encrypted message and resolve redundancies. The third step is to process the result with a pseudo-random number generator to make frequency-analysis types of attacks infeasible.

In a particular embodiment, the invention comprises the use of a 52-letter character set from which is formed a key, corresponding to all of the uppercase and lowercase letters in the English alphabet. By assigning the letters randomly, the use of 52 letters gives the possibility of an extremely large number of different assignments. This places the method beyond the reach of any reasonable brute force attack.

In order to increase the difficulty of attack, the system has alphabet assignment tables that may be changed after each letter assignment. Because the present invention can use a different key for each ciphertext, it fits the Shannon definition of a “perfect” cryptosystem.

The invention further comprises a multilevel ability that allows the representation of a letter with more than one letter. Although there is no theoretical limit on the number of levels, a large number of levels would be a computational burden, which may be somewhat decreased by the use of compression. The difficulty of breaking a message with a brute force attack can, however, be increased exponentially by simply assigning a higher level number for a particular encoding task. So long as the level number remains reasonable, the computational burden associated with using the present invention is still significantly less than previous techniques that are less secure. The ease of encoding and decoding with the present invention is one of its most important advantages over other cryptography systems.

An advantage of the present invention is that it allows a sender to encode data such that the data potentially contains two or more different messages. Receivers must have the right decoding parameters in order to decode intended messages, or they will read sensible messages that contain irrelevant meanings. This feature of the invention further frustrates many forms of traditional cryptoanalysis attacks. A typical cryptoanalysis program will not, for example, be able to determine which of multiple possible messages is the correct one. Thus the potential attacker is unable to determine if he or she has accessed the original plaintext even if sensible text is returned.

Another advantage of the present invention is that it may perform encode and decode functions in real time using any typical communication and storage system, such as a personal computer. This ability is the result of the relative simplicity of the calculations involved in its encoding and decoding processes.

Another advantage of the present invention is that, with the use of compression, the size of the message is not only reduced, which reduces latency, but also the entropy of the message is increased. This serves to thwart certain types of attacks. Compression is particularly helpful in defeating frequency-based attacks.

The present invention may be implemented as a secure communication system, which features an encoding module and decoding module at remote stations. The required key for the use of the present invention may be passed between these stations by means of a traditional public/private key encryption technique.

It may be seen that in any communication system, there are two main access points at which an unauthorized user may intercept messages. First, unauthorized users can read and decode posted messages. With the present invention, however, even if unauthorized users receive a message, they cannot resolve it without knowing the correct assignment. A second potential danger is that a party, perhaps unable to decode a message, may alter it. With the present invention, intended receivers could detect any distortion or alteration. This feature is a result of the compression feature of certain embodiments; since any alteration damages the parameter of the message compression, it will not be possible to decompress the message using the correct decompression sequence, and the intended recipient will thus know that the message has been altered or garbled in transmission.

### DRAWINGS

FIG. 1 is an overview of a communication system according to a preferred embodiment of the present invention.

FIG. 2 is a diagram of the communication and key delivery process component of a communication system according to a preferred embodiment of the present invention.

FIG. 3 is a diagram of the encoding sequence component of a communication system according to a preferred embodiment of the present invention.

FIG. 4 is a diagram of the decoding sequence component of a communication system according to a preferred embodiment of the present invention.

FIG. 5 is a flow chart depicting the message compression process of a communication system according to a preferred embodiment of the present invention.

FIG. 6 is a depiction of a screen display at a user terminal as part of a communication system according to a preferred embodiment of the present invention.

FIG. 7 is a depiction of the send frame of a screen display at a user terminal as part of a communication system according to a preferred embodiment of the present invention when a message is encoded and ready to be delivered.

FIG. 8 is a depiction of the send frame of a screen display at a user terminal as part of a communication system according to a preferred embodiment of the present invention when the same message of FIG. 7 is to be sent but at a higher decomposition level.

### PREFERRED EMBODIMENT(S)

The present invention comprises a dictionary-based substitution cipher with multilevel ability. In a preferred embodiment, the invention utilizes a character set that includes 26 uppercase letters, 26 lowercase letters, the number characters 0-9, and 29 special characters in a character dictionary that contains a total of 91 characters. These characters may be encoded using a 52-character set comprising only the uppercase and lowercase letters. Thus there are a total of 52!, or roughly 8×10⁶⁷, different permutations that may be achieved. The encoding strings corresponding to each letter are stored in a dictionary, or assignment table, for use by the encoding method.

Once text to be ciphered is presented by a user to the ciphering system of the preferred embodiment, a pseudo-random permutation set is generated as a key. The key is used in populating the encoding dictionary. In addition to generating text to be ciphered, the user will also generate a level number, which is used as a means to specify the required security level. The level number identifies the number of times the encryption routine should be executed while encoding the message.

In overview, the encoding process begins with the reading of each character from the text and its replacement with the corresponding dictionary entry combination. Suppose, for example, that the dictionary contains for entry “a” the code “cbLdr.” All occurrences of the letter “a” in the text to be encoded may thus be replaced by the characters “cbLdr.” The procedures continues until all characters of the text are thus encoded. This completes the first level of the encoding process.

If the level indicated for the encoding process is greater than one, then encoding continues at the next level until all levels are completed. For example, in the initial level all “a” characters in the text were replaced with “cbLdr.” Suppose now that the dictionary indicates that “c” is to be replaced with “pld”; b is to be replaced with “obN”; “L” is to be replaced with “adb”; “d” is to be replaced with “VLa”; and “r” is to be replaced with “oKEM.” The resulting coded text for level two corresponding to an “a” appearing in the original text would thus be “pidobNadbVLAoKEM.”

Once the message is fully encoded according to the specified level number, it is sent to a receiver. When the message is received, the decryption process works in the reverse order, using the pseudo-random generated key and the level number to arrive back at the original text. It will be seen that the size of the encoded message that must be sent and decoded is highly dependent upon the level number that is chosen.

To make the system more secure, the multilevel system of the preferred embodiment is capable of changing the dictionary alphabet assignment tables after each letter assignment. For instance, while the letter “a” may be represented at the first level as “cbLdr” in one encoding, that same assignment may not be valid later for the same level. When the text encryption is finished, the system encrypts the key and level number.

After encryption, the three encryption results (text, level number, and key) are then compressed. Compression removes not only redundancies in the ciphertext, but also increases the entropy of the ciphertext. The compression algorithm works in an adaptive manner. Starting from the beginning of the ciphertext, it checks for any repetitive pattern. Each repetition is replaced with an identifier, or pointer, that shows the first instance of the pattern. An exclusive-OR (XOR) operation is then applied to the compressed ciphertext and key to prevent successful cryptoanalysis by a party who knows how the algorithm works. Since only the intended receiver has the key, only the sender can recover the ciphertext from the XORed version of the ciphertext.

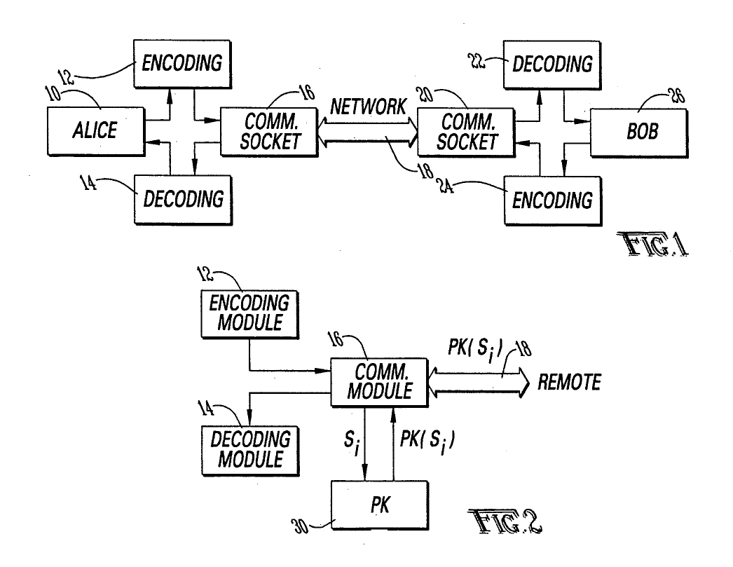

Turning now to a more detailed description of the preferred embodiment, and beginning with reference to FIG. 1, the architecture for the implementation of a system according to a preferred embodiment of the invention may now be described. Suppose that two people, Alice at block 10 and Bob at block 26, wish to exchange secure communications over network 18. Alice will require communication socket 16, and Bob will require communication socket 20, in order to communicate over network 18. According to a preferred embodiment, Alice at block 10 and Bob at block 26 may be using personal computers, although any other type of communication device may be used in the implementation of the invention. Further, any form of communication network may be used, although in the preferred embodiment network 18 is the Internet. In order to encode messages to be delivered to Bob at block 26, Alice at block 10 must use encoding block 12. She must use decoding block 14 to decode messages received from Bob. Likewise, Bob must use encoding block 24 in order to send encoded messages to Alice, and must use decoding block 22 in order to decode messages received from Alice.

It may be seen that in order for Alice and Bob to communicate using a symmetric key system, both must possess the key with which to encode and decode messages between them. This key, which will be designated as Sᵢ, is generated in the preferred embodiment using any of many known random or pseudo-random number generators. The random number generator should ideally be capable of generating any possible key within the key space with equal probability; this is one of the requirements for a “perfectly secure” system according to Shannon.

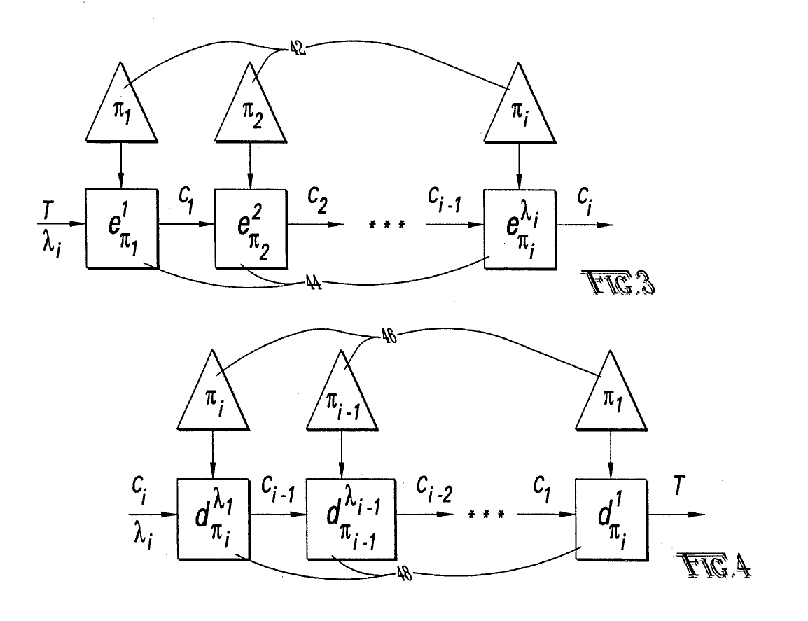

Once the key Sᵢ is generated, it may be sent from the party who generated the key (in this example, Alice) to the other party (in this example, Bob). Since the key Sᵢ is required to decode an incoming message, the general encoding algorithm cannot be used to send the key securely. In the preferred embodiment, a public key routine, shown in FIG. 2 as PK block 30, may be used. The user must first specify the remote system address using the user interface, as block 10 of FIG. 1, with the remote system address in the preferred embodiment being an Internet Protocol (IP) address of a remote user accessible through the Internet. Socket 16 communicates over network 18 and establishes a communications link with socket 20. Once the first message is encoded by encoding module 12, the associated key Sᵢ is delivered to socket 20 over network 18 in encrypted form (designated in FIG. 2 as PK(Sᵢ)) using public key module 30. In the preferred embodiment, the public key system uses a Deffie-Hellman key exchange algorithm, as is known in the art. Additionally, Digital Certification, also known in the art, may be used for authentication purposes if the remote system requires this level of security. During the first encoding during a communication session, socket 16 delivers to socket 20 a plaintext key. Alternatively, socket 16 could deliver the key along with the ciphertext and encoded level number using this private key method. After the first message in a communications session, the key is also preferably encoded in the message.

After delivering the first key, the system gives both the local and remote user the same assignment, and encoding module 12 may be used to encode the other keys Sᵢ and send them with the related encoded message. The user interface at block 10 sends the plaintext message and desired level number to encoding module 12. Encoding module 12 picks an assignment at random using the pseudo-random number generator, and encodes the plaintext and level number as described above. Note again that if this is the first message delivery, the key Sᵢ is sent as plaintext so that it can be delivered using public key encryption facilitated by public key module 30. For all other cases, key Sᵢ is preferably encoded using encoding module 12 along with the message itself.

The encoding process may now be described in greater detail. Suppose now that a plaintext source message is represented as T=Z₉₀, tᵢεT, where Z₉₀ denotes a domain with 90 elements, tᵢ is possible plaintext which is composed, as described above, of a possible 26 uppercase, 26 lowercase, 10 numerals, and 28 special characters, and i is the communication instance. Further suppose that the possible key space is represented as K=P₅₂, where πᵢεK represents the key driven from the pseudo-random number function πᵢ=Rnd(sᵢ)) in which sᵢ is the seed number for a particular communication instance. The enciphered text may be represented as C=Z₅₂, cᵢεC, where Z₅₂ denotes a domain with 52 elements, and cᵢ is possible enciphered text which is composed, as described above, of a possible 52 characters, composed of the 26 uppercase and 26 lowercase letters in the English alphabet. Based on these definitions, an initial message to be enciphered may be represented as:

$${c}_{i} = \{ \begin{matrix}[ {e}_{{π}_{i}}^{{l}_{i}} ( {t}_{i} ) ] ⋁ [ {e}_{{π}_{i - 1}}^{{l}_{i - 1}} ( {s}_{i} ) ] ⋁ [ {e}_{{π}_{i - 1}}^{{l}_{i - 1}} ( {l}_{i} ) ] & for i > 0 \\ PK ( {s}_{i} ) & for i = 0\end{matrix}$$

where lᵢ is the level number and e(x) is the encoding function. The encoding function e(x) may be represented as:
e_{π}_{ᵢ}^{l}^{ᵢ}(tᵢ)={α^{l}(πᵢ(α^{l-1}(πᵢ( . . . α¹(πᵢ(tᵢ)))))}.
The encoding function uses a previously created assignment table, which may be represented as:
α(πᵢ(tᵢ))=(wₘ)
where wεZ₅₂ represents the domain of 52 elements comprising in the preferred embodiment the 26 uppercase and 26 lowercase characters of the English alphabet, and m represents the number of W's between 0<m<10.

FIG. 3 illustrates in greater detail the encoding sequence performed by encoding block 12 of FIG. 1, applying the equations developed above. It may be seen that each of random number inputs 42 function to provide a pseudo-random number input to one of encoding blocks 44. At the left-most encoding block 44, the source text T and a level number lᵢ are input to encoding block 44. The output, passing between the first and second encoding blocks 44, is ciphered text cᵢ. This is the first-level version of the encrypted form of source text T. The process is repeated for succeeding encryption blocks 44 a successive number of times equal to the level number lᵢ initially input. The final output, cᵢ, is the source text T successively enciphered the number of times designated by the level number. The size of the string represented by cᵢ will of course be a function of the level number, with greater level numbers increasing the size of the string.

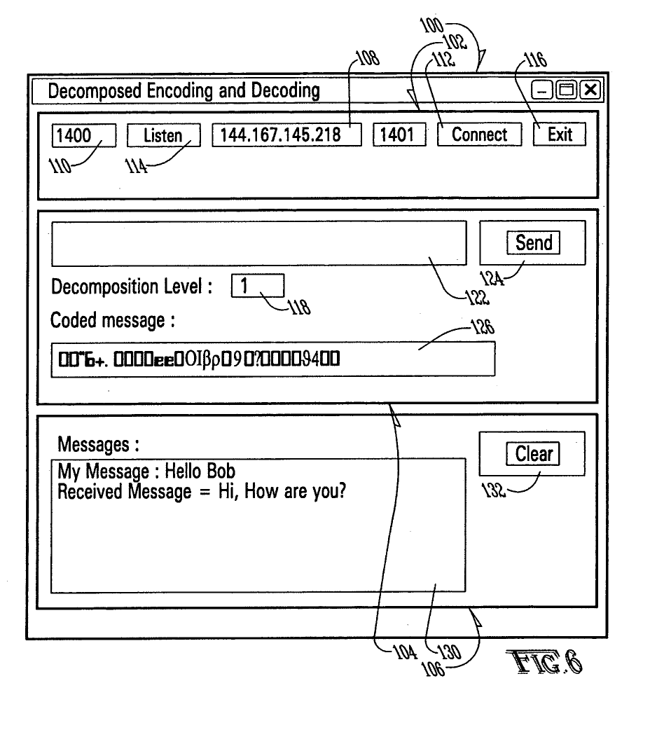

Encoding block 12 of FIG. 1 also includes the application of a compression algorithm with respect to output cᵢ of FIG. 3. In the preferred embodiment, the compression algorithm chosen is of the adaptive type. The central idea is to scan the encrypted text for multiple pattern occurrences and to replace them by internally known identifiers. Identifiers are dynamically decided by the system for each pattern in the encrypted text. Referring now to FIG. 5, this process may be described. The encrypted text cᵢ is received as input at input block 60. This data is read into the compression algorithm, one character at a time, at action block 62. Processing then proceeds to decision block 64. If a match is found in the existing compression dictionary with a previous character, then processing proceeds to decision block 66. If no match is found, then processing returns to action block 62 to read another character. If the last character has been read from the ciphertext block, then processing moves to output block 72 and the compressed ciphertext string is returned.

At decision block 66, the next character in the ciphertext string is checked to determine if it matches with the an entry in the dictionary. This process continues until a character is found that results in no match between the string being built and any string in the dictionary. At this point, processing moves to block 68, where a new reference identifier is assigned to this string and the string is replaced with this reference number in the ciphertext. At decision block 70, the system checks to see if the end of the ciphertext has been reached: if not, then processing returns to read another character at block 62; if so, then processing ends and the compressed ciphertext is returned at block 72.

It may be noted that the compression algorithm of the preferred embodiment is particularly designed to work well with small file sizes, as may be encountered for relatively short messages encrypted using the preferred embodiment of the present invention. Other popular compression algorithms, such as LZW and Huffman, may actually increase file size for very small file sizes. The compression algorithm of the preferred embodiment, by contrast, produces a relatively stable compression ratio.

After compression, the final stage of encoding in encoding block 12 of FIG. 1 is the application of an exclusive-OR (“XOR”) operation with respect to the ciphertext. It may be seen from a description of the compression algorithm that anyone who knows the compression method could decompress the ciphertext. In order to defeat this type of attack, the ciphertext is XORed with the system key. The XOR function, well known in the art, is a bitwise operator that returns a result of “0” when the compared bits are a match, and returns a result of “1” when the compared bits do not match (i.e., one bit is a “1” and the other is a “0”). After application of the XOR function, a potential eavesdropper cannot decompress the ciphertext, even knowing the algorithm by which compression was performed, since knowledge of the key would also be required. The output is then passed through communication socket 16 over network 18 in order to be received at communication socket 20.

Turning now to the decryption of a ciphered message after it is received at communication socket 20 of FIG. 1, the first step in decoding at block 22 is the bitwise application of the XOR function between the ciphertext and the key. It is a fundamental property of the XOR function that the result will be the original compressed ciphertext key prior to application of the XOR function at encoding block 12.

The next step during decoding at block 22 is to uncompress the ciphertext. It may be seen from a description of the compression algorithm above that a knowledge of the algorithm is all that is required to perform the decompression operation, which is essentially a reverse application of the compression algorithm described above and illustrated in FIG. 5. The result will be the uncompressed ciphertext, which will include the text itself, level, and new key in encrypted form.

Once the ciphertext cᵢ is uncompressed, it may be used along with the related level number lᵢ and assignment number (key) in the decoding process at decoding block 22 of FIG. 1. Decoding proceeds based upon the assignment and level number. A new alphabet table is created based upon the first-received assignment, and this table is used for further messaging. Note that in some embodiments, the user may desire to change the alphabet randomly or periodically to increase the complexity and reliability of the system. The deciphering process may be represented as:

$${t}_{i} = \{ \begin{matrix}{d}_{{π}_{i}}^{{l}_{i}} ( {c}_{i} ) & for i > 0 \\ {PK}^{- 1} ( {s}_{i} ) & for i = 0\end{matrix}$$

where d(x) is the decoding function. The decoding function d(x) may further be represented as:
d_{π}_{ᵢ}^{l}^{ᵢ}(cᵢ)={πᵢ⁻¹(α¹(πᵢ⁻¹(α²( . . . πᵢ⁻¹(α¹(cᵢ)))))}
with the same variable assignments as explained above, and in which case the assignment table is the same.

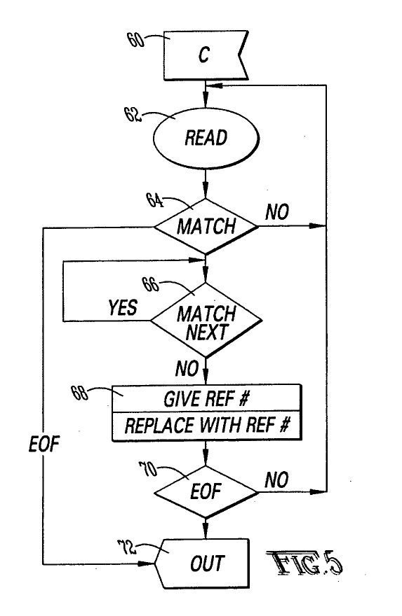

Turning to FIG. 4, the decoding sequence is illustrated in greater detail, applying the equations developed above. It may be seen that each of random number inputs 46 function to provide the assignment (pseudo-random number) input to one of decoding blocks 48. At the left-most decoding block 48, the ciphered text cᵢ and level number lᵢ are input to decoding block 48. The output, passing between the first and second decoding blocks 48, is ciphered text cᵢ₋₁. This is equivalent to a ciphered version of the original text at a level number one less than the level number at which encoding was performed. The process is repeated for succeeding decryption blocks 48 a successive number of times equal to the level number lᵢ initially input, each time resulting in an encrypted version of the original text at a lower level number. The final output, T, is the original source text entirely decrypted.

It may be seen from the foregoing that any alteration of the package sent over network 18 during transmission which reflects a change of information will result in an altered message that cannot be decoded on the receiver's side. Once this error is detected, it may be known that the package was interrupted or intercepted. This may be the result of many causes, either a malicious third-party attack or simple network congestion. In any case, communication socket 16 may be requested to re-send the message once it is determined that the message was not properly received.

A communication system according to a preferred embodiment of the present invention may now be described with reference to FIGS. 6-8. The interface screen 100, shown in FIG. 6, consists of three frames: connection frame 102, send frame 104, and receive frame 106. This same screen is visible to both parties during a communications session once the appropriate application is opened. The system is preferably implemented as software on a personal computer, but may be implemented in a myriad of other platforms as known to those in the art.

To establish a connection with a party with whom secure communications are desired, a user should specify a remote address by typing such address in address remote address window 108, and also typing a port number into port window 110. In the preferred embodiment, the remote address typed into remote address window 108 is an Internet Protocol (IP) address for directing the message to a particular node located on the Internet. Once this information is input, the user may click on connect button 112 to open a communications channel with a remote terminal. Likewise, listen button 114 should be depressed in order to allow the remote receiver/sender to connect to the specified port for sending a return message. Exit button 116 may be used to exit the application at any time.

Message encryption, key delivery, and the user's security requirements are handled by processing at send frame 104. Once a communications channel is opened, the connected users may send messages between each other using send frame 104. The user may select a desired decomposition level at level window 118. The message to be sent is entered at message window 122. This message will be entered here in plaintext form.

Once a message is entered into message window 122, send button 124 may be used to send the message to the user at the receiving terminal. Before the message is delivered, however, the software checks to see if this is the first communication attempt to the specified remote user. If that is the case, then a randomly generated permutation key is delivered using the public key approached described earlier. The other user's public key is requested and the first key is encrypted using the received public key, then sent to the remote user. This is a one-time operation only for the first message, in order to exchange secret keys between the users of the communication system.

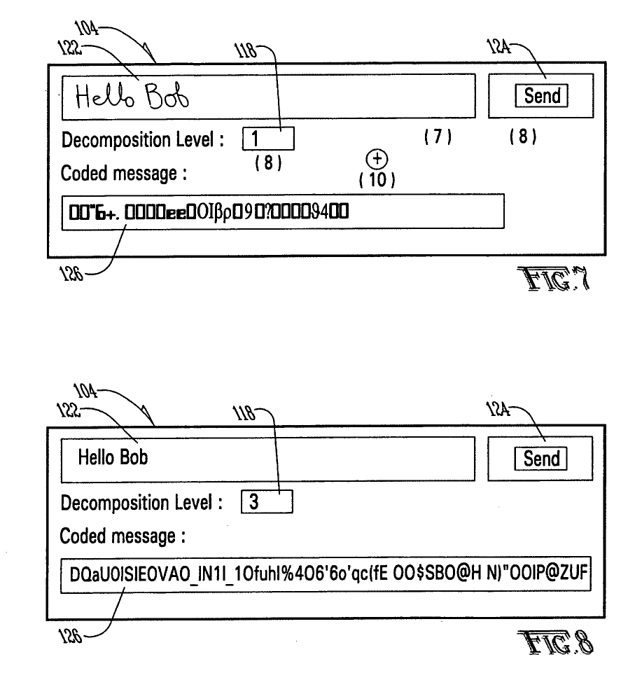

The encryption module as described earlier takes the message from message window 122, and the required level number from level window 118, and encrypts the message, level number, and the key. The encoded message (which, in the preferred embodiment, is also compressed and XORed with the key before sending) is then displayed in coded message window 126 of send frame 104. FIGS. 7 and 8 show examples of this process using, in the case of FIG. 7, a level number of 1 in level window 118, while in the case of FIG. 8 a level number of 3 in level window 118 is chosen. It may thus be seen that although the local and remote applications may be the same, they use different random numbers and assignments. As a result, the same message will not be encrypted to the same cipher text even for the same level number between remote and local applications. Also, since different assignments may be made for each message, even if the user wants to send an identical message at a later time, the ciphertext will be entirely different. Upon completion of the ciphering process, the encrypted message, the encrypted level number, and the encrypted key may be sent (after compression and the XOR operation) to the remote user via communications sockets by clicking send button 124.

Once the encrypted message, encrypted level number, and encrypted key are received at the remote terminal, those are passed to the decryption module for processing as described above. The module deciphers the message according to the associated level number and key. The deciphered message is printed in deciphered message window 130 of receive frame 106. Time of receipt information may also be included in deciphered message window if desired. The sent message may also be shown, in which case the sent and received messages may be distinguished in the scrolling window by appropriate labels, as shown in FIG. 6. Receive frame clear button 132 may be used to remove the text from message window 130 as desired by the user.

The present invention has been described with reference to certain preferred and alternative embodiments that are intended to be exemplary only and not limiting to the full scope of the present invention as set forth in the appended claims.

What is claimed is:

1. A method of encoding a message sent from a sender to a receiver, comprising the steps of: (a) generating a first character set; (b) generating a key comprising characters within the first character set; (c) creating a sender assignment table using the key, the sender assignment table comprising a plurality of values corresponding to each character in the first character set, and each of the sender assignment table values comprised of characters from a second character set; (d) substituting each character in a plaintext message comprised of the first character set with the corresponding sender assignment table value to create a ciphertext message; (e) repeating said substitution step a number of times equal to a specified level number, each repetition being performed upon the ciphertext message resulting from the preceding substitution step; and (f) passing the ciphertext message resulting from said repetition of said substitution step with the level number to a receiver.

2. The method of claim 1, further comprising the step of compressing the ciphertext message to result in a compressed ciphertext message.

3. The method of claim 2, wherein said compression step comprises the substitution of at least one string in the ciphertext message with an identifier.

4. The method of claim 2, further comprising the step of performing an exclusive-OR (XOR) operation between the compressed ciphertext message and the key.

5. The method of claim 1, wherein said key is generated using one of a random and pseudo-random number generator.

6. The method of claim 5, wherein said key is a string comprised of each of the characters of the first character set in one of a random and pseudo-random order.

7. The method of claim 1, further comprising the step of passing the key and the level number to a receiver with the ciphertext message.

8. The method of claim 7, further comprising the step of, in a first communication, passing the key to a receiver using a public-key encryption system.

9. The method of claim 8, further comprising the step of, in a second and all subsequent communications, encrypting the key in the same manner as the plaintext message before sending the key to the receiver.

10. The method of claim 9, further comprising the step of substituting the level number with the corresponding sender assignment table value for the character representing the level number to create a ciphertext level number, and passing the ciphertext level number to a receiver with the ciphertext message.

11. The method of claim 10, further comprising the steps of receiving the plaintext message from a first graphical user interface in communication with the sender, and displaying the plaintext message at a second graphical user interface in communication with the receiver.

12. The method of claim 1, further comprising the steps of:
(a) using the received key to create a receiver assignment table, the receiver assignment table comprising a plurality of values corresponding to each character in the first character set, and each of the receiver assignment table values comprised of characters from the second character set;
(b) substituting each character string in the ciphertext message corresponding to a receiver assignment table value with the corresponding character to create a resultant message; and
(c) repeating said substitution step a number of times equal to the specified level number, each repetition being performed upon the resultant message resulting from the preceding substitution step until a plaintext message is generated.

13. The method of claim 12, further comprising the step of decompressing the ciphertext message to result in a decompressed ciphertext message.

14. The method of claim 13, wherein said decompression step comprises the substitution of at least one identifier in the ciphertext message with a character string.

15. The method of claim 13, further comprising the step of performing an exclusive-OR (XOR) operation between the ciphertext message and the key prior to said decompression step.

16. A system for the transmission of encoded messages, comprising:
(a) a network operable to transmit messages;
(b) first and second communication sockets connected to said network wherein said first communication socket is operable to send a message over said network to said second communication socket;
(c) an encoding module in communication with said first communication socket, said encoding module comprising:
(i) a key generation module operable to generate a key;
(ii) an encoding assignment table generation module operable to generate an assignment table using the key, wherein the assignment table comprises each possible character in a plaintext message and a corresponding substitution character set for each such character; and
(iii) an encoding substitution module operable to generate a ciphertext message from a plaintext message by substituting for each character in a plaintext message the corresponding substitution character set for each such character, and repeating such operation on the resulting ciphertext message a number of times equal to a level number;
(d) a decoding module in communication with said second communication socket, said decoding module comprising:
(i) a decoding assignment table generation module operable to generate an assignment table using a key, wherein the assignment table comprises each possible character in a plaintext message and a corresponding substitution character set for each such character; and
(ii) a decoding substitution module operable to generate a plaintext message from a ciphertext message by substituting for each substitution character set in a ciphertext message the corresponding character, and repeating such operation on the resulting message a number of times equal to a level number, resulting in a plaintext message;
(e) a first user interface in communication with said encoding module wherein said first user interface is operable to receive as input a plaintext message and a level number and communicate said plaintext message and said level number to said encoding module; and
(f) a second user interface in communication with said decoding module wherein said second user interface is operable to display as output a plaintext message received from said decoding module.

17. The system of claim 16, wherein said encoding module further comprises a compression module operable to receive the ciphertext message and output a compressed ciphertext message.

18. The system of claim 17, wherein said compression module is operable to substitute at least one string in the ciphertext message with an identifier.

19. The system of claim 17, wherein said encoding module further comprises an exclusive-OR (XOR) module operable to perform an XOR function with respect to the compressed ciphertext message and the key.

20. The system of claim 17, wherein said decoding module further comprises a decompression module operable to receive the compressed ciphertext message and output a decompressed ciphertext message.

21. The system of claim 20, wherein said decompression module is operable to substitute at least one identifier in the ciphertext message with a string.

22. The system of claim 21, wherein said decoding module further comprises an exclusive-OR (XOR) module operable to perform an XOR function with respect to the compressed ciphertext message and the key.

23. The system of claim 16, wherein said key generation module comprises one of a random and pseudo-random number generator.

24. The system of claim 16, wherein each said substitution character set is comprised of a first set of characters, and said key generation module is operable to create a key of a length equal to the number of characters in said first character set.

25. The system of claim 16, wherein said first communication socket is further operable to transmit said level number and said key over said network to said second communication socket.

26. The system of claim 16, wherein said encoding substitution module is operable to encode said key by substituting for each character in said key the corresponding substitution character set for each such character, and repeating such operation a number of times equal to a level number.

27. The system of claim 16, wherein said decoding substitution module is operable to decode said key by matching substitution character sets from the key and substituting the corresponding character, and repeating such operation on a resulting intermediate key string a number of times equal to a level number.

28. The system of claim 16, further comprising a public key encryption module in communication with said first communication socket, said public key encryption module operable to encode a key according to a public key encryption routine.

29. The system of claim 16, wherein said second communication socket is further operable to send a message over said network to said second communication socket, said second user interface is further operable to receive as input said plaintext message and said level number and communicate said plaintext message and said level number to said second encoding module, said first user interface is further operable to display as output the plaintext message received from said second decoding module, and further comprising:
(a) a second encoding module in communication with said second communication socket, said second encoding module comprising:
(i) a second key generation module operable to generate a key;
(ii) a second encoding assignment table generation module operable to generate an assignment table using the key, wherein the assignment table comprises each possible character in a plaintext message and a corresponding substitution character set for each such character; and
(iii) a second encoding substitution module operable to generate a ciphertext message from a plaintext message by substituting for each character in a plaintext message the corresponding substitution character set for each such character, and repeating such operation on the resulting ciphertext message a number of times equal to a level number; and
(b) a second decoding module in communication with said first communication socket, said second decoding module comprising:
(i) a second decoding assignment table generation module operable to generate an assignment table using a key, wherein the assignment table comprises each possible character in a plaintext message and a corresponding substitution character set for each such character; and
(ii) a second decoding substitution module operable to generate a plaintext message from a ciphertext message by substituting for each substitution character set in a ciphertext message the corresponding character, and repeating such operation on the resulting message a number of times equal to a level number, resulting in a plaintext message.

30. A method of communicating between a first and second node using encoded messages, comprising the steps of:
(a) receiving a plaintext message and a level number at the first node;
(b) generating a key at the first node;
(c) creating a first assignment table at the first node using the key, wherein the first assignment table comprises an assignment table value corresponding to each possible character in the plaintext message;
(d) substituting each character in the plaintext message with the corresponding assignment table value to create a ciphertext message, and repeating said substitution step a number of times equal to the level number, each repetition being performed upon the ciphertext message resulting from the preceding substitution step;
(e) substituting a character representing the level number with the corresponding assignment table value to create a ciphertext level number;
(f) encrypting the key with a public key encryption technique;
(g) passing the public-key encrypted key to the second node; and
(h) passing the ciphertext message and ciphertext level number to the second node.

31. The method of claim 30, further comprising the step of compressing the ciphertext message to result in a compressed ciphertext message.

32. The method of claim 31, wherein said compression step comprises the substitution of at least one string in the ciphertext message with an identifier.

33. The method of claim 31, further comprising the step of performing an exclusive-OR (XOR) operation between the compressed ciphertext message and the key.

34. The method of claim 30, further comprising the steps of:
(a) receiving the public-key encrypted key and the encrypted ciphertext message and ciphertext level number at the second node;
(b) decrypting the public-key encrypted key using the public-key encryption technique;
(c) creating a second assignment table at the second node using the key, wherein the second assignment table comprises an assignment table value corresponding to each possible character in the plaintext message;
(d) substituting the ciphertext level number with the character corresponding to its assignment table value to generate the level number;
(e) substituting each character string in the ciphertext message corresponding to an assignment table value with the corresponding character to create a resultant message, and repeating said substitution step a number of times equal to the level number, each repetition being performed upon the resultant message resulting from the preceding substitution step until a plaintext message is generated.

35. The method of claim 34, further comprising the step of decompressing the ciphertext message to result in a decompressed ciphertext message.

36. The method of claim 35, wherein said decompression step comprises the substitution of at least one identifier in the ciphertext message with a string.

37. The method of claim 35, further comprising the step of performing an exclusive-OR (XOR) operation between the compressed ciphertext message and the key prior to said decompression step.

38. The method of claim 34, further comprising the steps of:
(a) receiving a second plaintext message at the first node;
(b) substituting each character in the second plaintext message with the corresponding assignment table value to create a second ciphertext message, and repeating said substitution step a number of times equal to the level number, each repetition being performed upon the second ciphertext message resulting from the preceding substitution step;
(c) substituting each character in the key with the corresponding assignment table value to create a ciphertext key; and
(g) passing the ciphertext message, ciphertext level number, and ciphertext key to the second node.
